(19) United States
(12) Patent Application Publication
(10) Pub. No.: US 2026/0086345 A1
(43) Pub. Date: Mar. 26, 2026

(54) ENDOSCOPE DISTAL END PORTION AND ENDOSCOPE

(71) Applicant: OLYMPUS MEDICAL SYSTEMS CORP., Tokyo (JP)

(72) Inventors: Yasushi NAMII, Tokyo (JP); Yuta SATO, Tokyo (JP); Takeshi TACHIBANA, Tokyo (JP)

(73) Assignee: OLYMPUS MEDICAL SYSTEMS CORP., Tokyo (JP)

(21) Appl. No.: 19/251,949

(22) Filed: Jun. 27, 2025

(30) Foreign Application Priority Data
Sep. 26, 2024 (JP) 2024-167679

(51) Int. Cl. G02B 23/24; G02B 1/02

(52) U.S. Cl. CPC G02B 23/243; G02B 1/02; G02B 23/2415; G02B 23/2484

(57) ABSTRACT

An endoscope distal end portion includes: a cylindrical distal end member including a first through-hole having an enlarged diameter region formed in a first distal end surface; a first optical element that is fitted into the enlarged diameter region, is made of a single crystal sapphire having a thermal expansion coefficient smaller than that of the distal end member, and has a circular second distal end surface; and solder sealing a gap between a side surface of the first optical element and an inner surface of the enlarged diameter region. A c-axis direction of the single crystal sapphire is substantially parallel to a first imaginary line connecting a surface center point of the first distal end surface, a first neighbor point on an outer circumference of the first distal end surface which is closest to the first optical element, and a first center point of the first through-hole.

### CROSS REFERENCE TO RELATED APPLICATION

This application claims the benefit of Japanese Application No.2024-167679 filed in Japan on Sep. 26, 2024, the contents of which are incorporated herein by this reference.

### BACKGROUND OF THE INVENTION

### 1. Field of the Invention

The present disclosure relates to an endoscope distal end portion in which an optical element is watertightly fixed to a distal end member, and an endoscope including an endoscope distal end portion in which an optical element is watertightly fixed to a distal end member.

### 2. Description of the Related Art

Endoscopes are widely used to insert a long, thin insertion section into the body of a subject that cannot be observed from the outside, and to observe the inside of the body using a camera unit installed at the distal end portion, or to perform treatment/procedures using a treatment instrument protruded from the distal end portion. The endoscopes after use are disinfected and sterilized to prevent infection between patients.

As a disinfection sterilization method of an endoscope, an autoclaving method (high-temperature and high-pressure steam method) becomes the mainstream method. The autoclaving method can be used immediately after sterilization without complicated work and can be performed at low running costs.

In the autoclaving method, the entire endoscope is exposed to a high temperature, high pressure, and high humidity state. Hence, there is a possibility that an O-ring or the like for watertight sealing of a distal end member and an optical system such as a camera unit disposed in a through-hole of a distal end rigid member is likely to deteriorate and water vapor may infiltrate the optical system. When the water vapor enters the optical system, the optical element (a cover glass, a lens) becomes cloudy, and this makes it impossible to acquire an appropriate image.

JP 2002-253487 A discloses an endoscope in which an optical element on the outermost surface is fixed to a distal end member using solder. The endoscope realizes highly reliable watertight sealing by using solder which is a metal material, as a bonding member.

### SUMMARY OF THE INVENTION

An endoscope distal end portion of an embodiment includes: a cylindrical distal end member that has a first through-hole having an enlarged diameter region which is formed in a first distal end surface; a first optical element that is fitted into the enlarged diameter region, is made of a single crystal sapphire having a thermal expansion coefficient smaller than a thermal expansion coefficient of the distal end member, and has a circular second distal end surface; and solder sealing a gap between a side surface of the first optical element and an inner surface of the enlarged diameter region of the first through-hole. A c-axis direction of the single crystal sapphire is substantially parallel to a first imaginary line connecting a surface center point of the first distal end surface of the distal end member, a first neighbor point on an outer circumference of the first distal end surface which is closest to the first optical element, and a first center point of the first through-hole.

An endoscope of another embodiment includes an endoscope distal end portion at a distal end portion of an insertion portion. The endoscope distal end portion includes a cylindrical distal end member that has a first through-hole having an enlarged diameter region which is formed in a first distal end surface, a first optical element that is fitted into the enlarged diameter region, is made of a single crystal sapphire having a thermal expansion coefficient smaller than a thermal expansion coefficient of the distal end member, and has a circular second distal end surface, and solder sealing a gap between a side surface of the first optical element and an inner surface of the enlarged diameter region of the first through-hole. A c-axis direction of the single crystal sapphire is substantially parallel to a first imaginary line connecting a surface center point of the first distal end surface of the distal end member, a first neighbor point on an outer circumference of the first distal end surface which is closest to the first optical element, and a first center point of the first through-hole.

### BRIEF DESCRIPTION OF THE DRAWINGS

FIG. 1 is a diagram illustrating an endoscope system including an endoscope according to an embodiment;

FIG. 2 is an exploded cross-sectional view of an endoscope distal end portion according to a first embodiment;

FIG. 3 is a cross-sectional view of the endoscope distal end portion according to the first embodiment;

FIG. 4 is a plan view of a distal end surface of the endoscope distal end portion according to the first embodiment;

FIG. 5 is a plan view of a distal end surface of an endoscope distal end portion according to Modification Example 1 of the first embodiment;

FIG. 6 is a plan view of a distal end surface of an endoscope distal end portion according to Modification Example 2 of the first embodiment;

FIG. 7 is a plan view of a distal end surface of an endoscope distal end portion according to Modification Example 3 of the first embodiment;

FIG. 8 is a plan view of a distal end surface of an endoscope distal end portion according to a second embodiment;

FIG. 9 is a plan view of a distal end surface of an endoscope distal end portion according to Modification Example 1 of the second embodiment;

FIG. 10 is a plan view of a distal end surface of an endoscope distal end portion according to a third embodiment;

FIG. 11 is an exploded cross-sectional view of an endoscope distal end portion according to a fourth embodiment; and

FIG. 12 is a plan view of a distal end surface of the endoscope distal end portion according to the fourth embodiment.

### DETAILED DESCRIPTION OF THE PREFERRED EMBODIMENT(S)

Hereinafter, embodiments of the present disclosure will be described with reference to drawings. The drawings based on the embodiments are schematic. Illustration and reference numerals of some components are omitted.

### First Embodiment

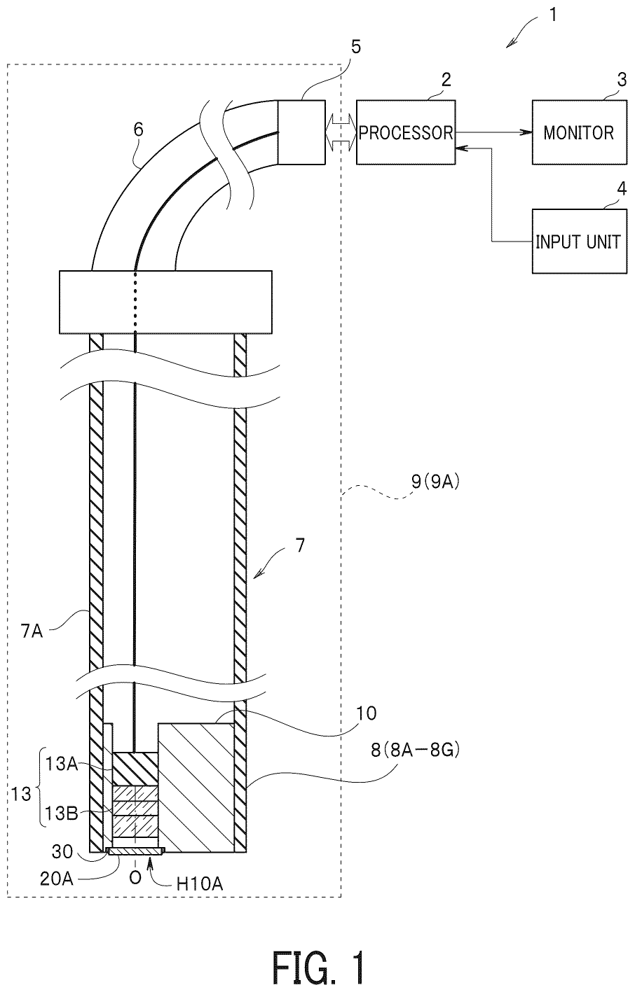

As illustrated in FIG. 1, an endoscope 9 according to the present embodiment constitutes an endoscope system 1, together with a processor 2 that processes an image signal, a monitor 3, and an input unit 4.

The endoscope 9 includes an elongated insertion portion 7 configured to be inserted into a body and a universal cord 6 extending from the insertion portion 7 via an operation unit (not illustrated). An endoscope distal end portion 8 of the insertion portion 7 includes a cylindrical distal end member 10, a cover glass 20A that is a first optical element, a camera unit 13, and solder 30 by which the cover glass 20A is watertightly fixed to the distal end member 10. An outer circumferential surface of the insertion portion 7 is covered with a flexible resin 7A.

The camera unit 13 includes an image pickup device 13A such as a CCD, and an objective optical system 13B including a plurality of lenses. The universal cord 6 has, on a proximal end portion side, an electronic connector 5 connected to the processor 2. An object image picked up by the camera unit 13 is subjected to signal processing by the processor 2 and displayed on a screen of the monitor 3. A user performs setting of the endoscope 9 and the processor 2 by using the input unit 4. The input unit 4 receives an instruction or the like indicating brightness, contrast, or color adjustment of a display image on the monitor 3. In addition, the input unit 4 can receive, as input, an instruction to change a light emission amount or an illumination wavelength range of a light source (a laser, an LED, a xenon lamp, or the like) (not illustrated) which is an illumination optical system of the endoscope 9. In response to an instruction of the input unit 4, light emitted from the light source is controlled by the processor 2 and is incident on an optical fiber bundle (not illustrated), and set illumination light is emitted from an illumination lens system of the endoscope distal end portion.

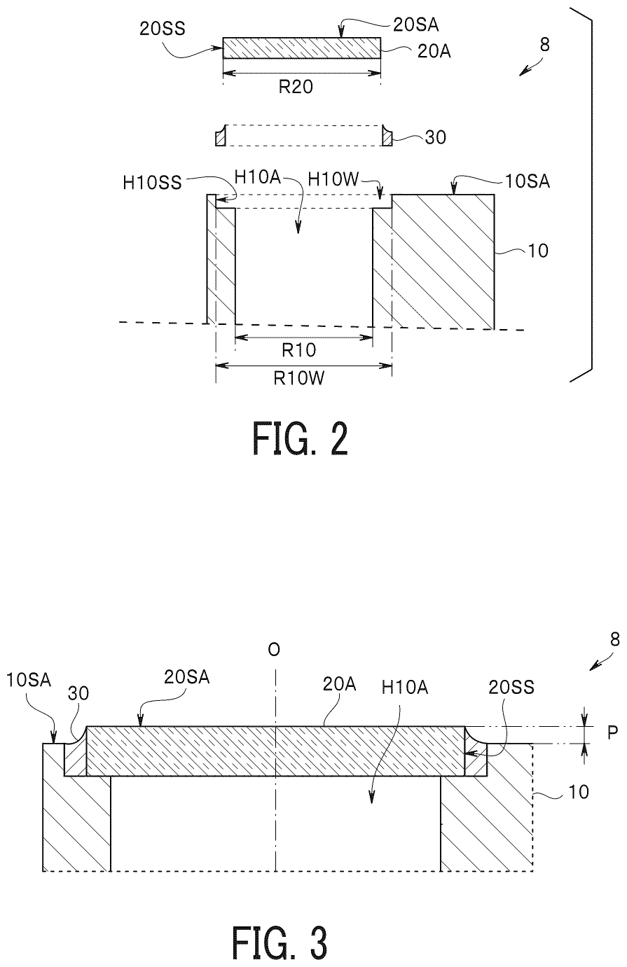

As illustrated in FIGS. 2 and 3, the distal end member 10 of the endoscope distal end portion 8 has a first through-hole H10A having a circular opening in a first distal end surface 10SA. The camera unit 13 is accommodated in the first through-hole H10A. The cover glass 20A closes the opening of the first through-hole H10A and is fixed to the distal end member 10 by the solder 30. An optical axis O of the camera unit 13 coincides with a central axis of the first through-hole H10A.

The first through-hole H10A has an enlarged diameter region H10W having a circular opening on the first distal end surface 10SA side. The enlarged diameter region H10W is a surface region of the first through-hole H10A formed by a so-called countersinking process to have a larger inner diameter which is a cross-sectional area than an inner diameter of a deep portion. In a case where the distal end member 10 is formed by injection molding or the like in which a resin is poured into a mold, the enlarged diameter region H10W may be taken into consideration at the time of mold design.

The cover glass 20A is fitted into the enlarged diameter region H10W. That is, a diameter R20 of the cover glass 20A is smaller than an inner diameter R10W of the enlarged diameter region H10W and larger than an inner diameter R10 of the first through-hole H10A. The diameter R20 of the cover glass 20A is smaller than the inner diameter R10W of the enlarged diameter region H10W by, for example, 1 μm to 30 μm. Note that an outer diameter of the first distal end surface 10SA is, for example, 1 mm to 5 mm.

The solder 30 has a ring shape to seal a gap between a side surface 20SS of the cover glass 20A and an inner surface H10SS of the enlarged diameter region H10W of the first through-hole H10A. The side surface 20SS of the cover glass 20A and the inner surface H10SS of the enlarged diameter region H10W are coated with, for example, a metal film in order to improve solderability. The side surface 20SS of the cover glass 20A may be coated with a black layer containing carbon in order to prevent flare or ghost.

Note that the solder 30 may not completely fill the gap as long as the gap is sealed. For example, in FIG. 3, the solder 30 does not need to be provided to a lower portion of the gap.

The cover glass 20A is a parallel-plate single crystal sapphire. The distal end member 10 is a rigid member made of stainless steel. The solder 30 is lead-free solder containing at least one of Zn, Sb, Al, and In.

As already described, a linear thermal expansion coefficient (α20 ≈7 ppm/° C.) of the single crystal sapphire is smaller than a linear thermal expansion coefficient (α10≈17 ppm/° C.) of stainless steel. Therefore, when heating is performed to a melting temperature (for example, 300° C.) of the solder 30 or higher in order to fix the cover glass 20A to the distal end member 10 by using the solder 30, and then the temperature returns to room temperature (for example, 25° C.), stress is applied to the cover glass 20A.

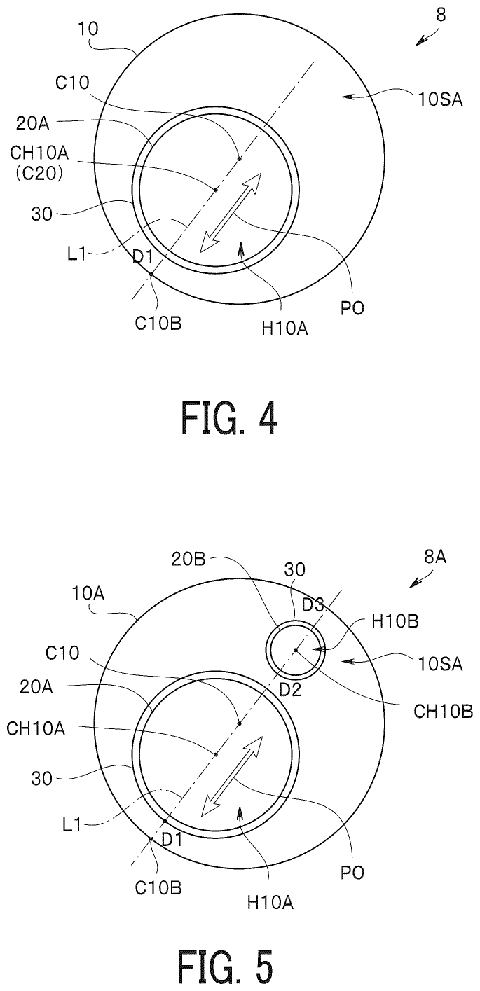

As illustrated in FIG. 4, the stress is applied to the cover glass 20A along a first imaginary line L1 connecting a surface center point C10 of the first distal end surface 10SA of the distal end member 10, a first neighbor point C10B on an outer circumference of the first distal end surface 10SA which is closest to the cover glass 20A, and a center point CH10A of the first through-hole H10A (a first center point C20A of the cover glass 20A). The largest stress is applied to the cover glass 20A in the vicinity of a region D1 in which a thickness (a dimension parallel to the first distal end surface 10SA) of the distal end member 10 is thinnest on the first distal end surface 10SA.

As illustrated in FIG. 4, the endoscope distal end portion 8 is disposed to have a c-axis direction PO of the sapphire which is substantially parallel to the first imaginary line L1. Note that “substantially parallel” means, for example, that the c-axis direction PO with respect to the first imaginary line L1 is ±20 degrees or smaller, particularly ±5 degrees or smaller.

The single crystal sapphire which has a high hardness so as not to be easily scratched and may be used as an optical element has a plane orientation in which the flexural strength is not high. Hence, when a single crystal sapphire element is fixed to the distal end member by using the solder, there is a possibility that the single crystal sapphire element will be damaged by stress generated due to a difference between thermal expansion coefficients or reliability will be degraded.

The single crystal sapphire has the highest flexural strength in a c-axis direction. Since a direction in which strong stress is applied is a direction in which the flexural strength is high, the cover glass 20A is not likely to be damaged.

Since a space between the cover glass 20A and the distal end member 10 is sealed by the solder 30, the endoscope distal end portion 8 has high watertight sealing performance. In addition, since there is no possibility that the cover glass 20A will be damaged by stress, the endoscope distal end portion 8 is highly reliable. The endoscope 9 having the endoscope distal end portion 8 has high watertight sealing performance and is highly reliable.

The enlarged diameter region H10W provided in the distal end member 10 in this manner makes it easy to perform watertight sealing assemble by solder bonding of the cover glass 20A.

Note that as illustrated in FIG. 3, a thickness of the cover glass 20A is larger than a depth (a countersunk depth: a size in a direction of the optical axis O) of the enlarged diameter region H10W. Therefore, a second distal end surface 20SA of the cover glass 20A projects by a predetermined projection length P from the first distal end surface 10SA of the distal end member 10.

The projection length P may be more than 0.1 mm and less than 0.3 mm. This is because, when the projection length P falls within the above-described range, the stress applied to the cover glass 20A is smaller than in a case where the projection length P is outside the above-described range.

Instead of the cover glass 20A as the first optical element, a plano-concave lens may be fitted into the enlarged diameter region H10W and fixed therein by the solder 30. In addition, in the cover glass 20A, an edge line on which the second distal end surface 20SA and the side surface 20SS intersect may be chamfered.

As described above, in the endoscope having the endoscope distal end portion at the distal end portion of the insertion portion, the endoscope distal end portion includes the cylindrical distal end member having the first through-hole in the first distal end surface, the first optical element that is fitted into the first through-hole on a distal end side, is made of the single crystal sapphire having the thermal expansion coefficient smaller than the thermal expansion coefficient of the distal end member, and has the circular second distal end surface, and the solder sealing the gap between the side surface of the first optical element and an inner surface of the first through-hole on a distal end side. The c-axis direction of the single crystal sapphire is substantially parallel to the first imaginary line connecting the surface center point of the first distal end surface of the distal end member, the first neighbor point on the outer circumference of the first distal end surface which is closest to the first optical element, and the first center point of the first through-hole.

Next, Modification Examples and the like of the embodiment will be described. Endoscope distal end portions 8A to 8E to be described below are similar to the endoscope distal end portion 8. Therefore, the same components as those of the endoscope distal end portion 8 are denoted by the same reference numerals as those of the endoscope distal end portion 8, and description thereof is omitted.

### Modification Example 1 of First Embodiment

A distal end member 10A of the endoscope distal end portion 8A of the present modification example illustrated in FIG. 5 has a second through-hole H10B having a second center point CH10B on an extension line of the first imaginary line L1. A cover glass 20B which is a second optical element of the illumination optical system is fitted into an enlarged diameter region of the second through-hole H10B. The cover glass 20B is fixed to the distal end member 10A by the solder 30. The illumination optical system is an optical system of illumination light for illuminating the subject.

Large stress is applied to the cover glass 20A in the vicinity of the region D1 and in the vicinity of a region D2 where a thickness of the distal end member 10A becomes thin on the first distal end surface 10SA.

The second center point CH10B of the second through-hole H10B is located on the extension line of the first imaginary line L1, and the region D1 and the region D2 are located on the extension line of the first imaginary line L1. Therefore, a direction of the stress is parallel to the first imaginary line L1. The cover glass 20B is disposed to have the c-axis direction PO of the sapphire which is substantially parallel to the first imaginary line L1. Therefore, there is no possibility that the cover glass 20B will be damaged.

Note that large stress is applied to the cover glass 20B in the vicinity of the region D2 and in the vicinity of a region D3 where the thickness of the distal end member 10A becomes thin on the first distal end surface 10SA. A direction of the stress is parallel to the first imaginary line L1. Therefore, in a case where the cover glass 20B is made of the single crystal sapphire, the cover glass 20B is disposed to have the c-axis direction PO of the sapphire which is substantially parallel to the first imaginary line L1. Hence, there is no possibility that the cover glass 20B will be damaged.

### Modification Example 2 of First Embodiment

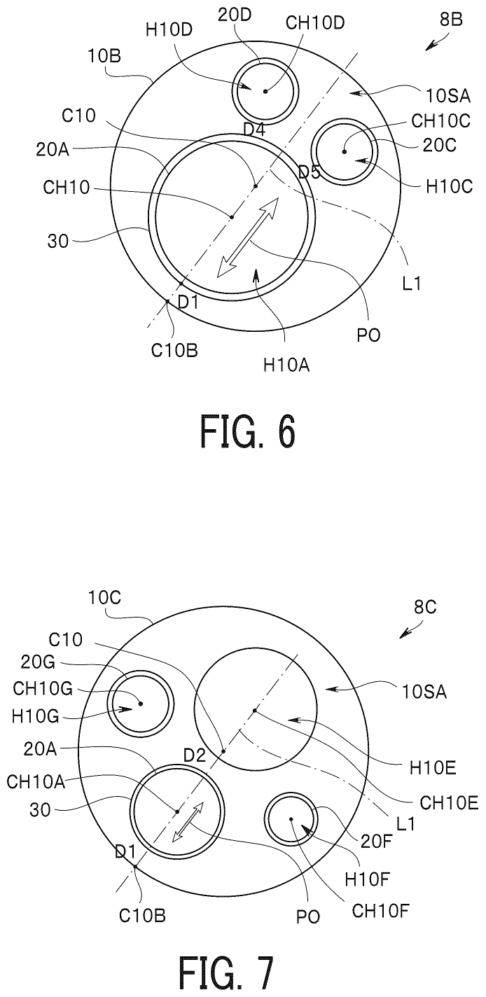

A distal end member 10B of the endoscope distal end portion 8B of the present modification example illustrated in FIG. 6 includes a third through-hole H10C having a third center point CH10C and a fourth through-hole H10D having a fourth center point CH10D at two line-symmetrical positions with an extension line of the first imaginary line L1 as a center line.

An illumination optical system is disposed in each of the third through-hole H10C and the fourth through-hole H10D. Similarly to the second through-hole H10B, the third through-hole H10C has an enlarged diameter region, and a third optical element (a cover glass 20C) is fixed to the enlarged diameter region by using the solder 30. Similarly to the third through-hole H10C, the fourth through-hole H10D has an enlarged diameter region, and a fourth optical element (a cover glass 20D) is fixed to the enlarged diameter region by using the solder 30.

Large stress is applied to the cover glass 20A in the vicinity of the region D1, in the vicinity of a region D4, and in the vicinity of a region D5 where a thickness of the distal end member 10B becomes thin on the first distal end surface 10SA. A direction of total stress of stress applied to the region D4 and stress applied to the region D5 is parallel to the first imaginary line L1. In the endoscope distal end portion 8B, since the cover glass 20A is disposed to have the c-axis direction PO of the sapphire which is substantially parallel to the first imaginary line L1. Hence, there is no possibility that the cover glass 20A will be damaged.

Directions of stresses applied to the cover glasses 20C and 20D, respectively, are not parallel to the first imaginary line L1, but are substantially parallel to each other. In a case where the cover glasses 20C and 20D are made of the sapphire, there is no possibility that the cover glasses 20C and 20D will be damaged when the cover glasses 20C and 20D are disposed to have the c-axis direction PO of the sapphire which is substantially parallel to the first imaginary line L1.

### Modification Example 3 of First Embodiment

A distal end member 10C of the endoscope distal end portion 8C of the present modification example illustrated in FIG. 7 has a fifth through-hole H10E having a fifth center point CH10E on an extension line of the first imaginary line L1. The fifth through-hole H10E is, for example, a forceps port. That is, an opening of the through-hole may not be covered with the optical element.

In addition, the distal end member 10C has a sixth through-hole H10F having a sixth center point CH10F and a seventh through-hole H10G having a seventh center point CH10G at two line-symmetrical positions with an extension line of the first imaginary line L1 as a center line.

A cover glass 20F which is a sixth optical element of the illumination optical system is disposed in the sixth through-hole H10F, and a cover glass 20G which is a seventh optical element of the illumination optical system is disposed in the seventh through-hole H10G.

Similarly to the endoscope distal end portion 8A, the largest stress is applied to the cover glass 20A in the vicinity of the region D1 and in the vicinity of the region D2, and a stress direction is parallel to the first imaginary line L1. In the endoscope distal end portion 8C, since the cover glass 20A is disposed to have the c-axis direction PO of the sapphire which is substantially parallel to the first imaginary line L1. Hence, there is no possibility that the cover glass 20A will be damaged.

Note that in a case where the distal end member has a plurality of through-holes, among the plurality of through-holes, a through-hole having a center point on an extension line of the first imaginary line may be the largest.

### Second Embodiment

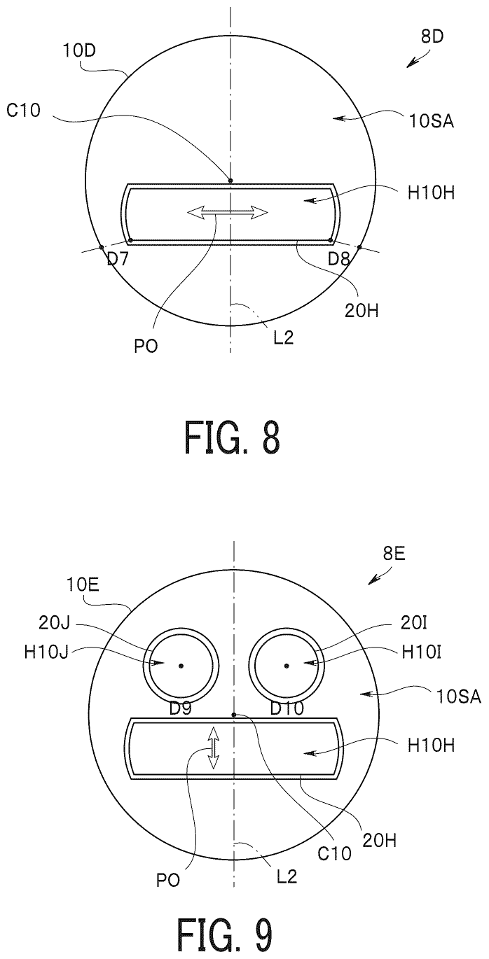

A distal end member 10D of the endoscope distal end portion 8D of the present embodiment illustrated in FIG. 8 has an eighth through-hole H10H having a substantially rectangular opening in the first distal end surface 10SA. The eighth through-hole H10H has an expansion region having a substantially rectangular opening, and a cover glass 20H which is an eighth optical element having a substantially rectangular shape is fixed to the expansion region by using the solder 30.

The rectangular eighth through-hole H10H is disposed line-symmetrically with respect to a second imaginary line L2 passing through a center of the first distal end surface 10SA. The second imaginary line L2 is orthogonal to a long axis direction of the cover glass 20H.

The eighth through-hole H10H accommodates, for example, a camera unit for picking up a stereoscopic image in which two camera units are arranged in parallel.

Large stress is applied to the cover glass 20H in the vicinity of a region D7 and in the vicinity of a region D8 where a thickness of the distal end member 10D becomes thin on the first distal end surface 10SA. A direction of total stress of stress applied to the region D7 and stress applied to the region D8 is substantially parallel to the long axis direction of the cover glass 20H. Therefore, the cover glass 20H is disposed to have the c-axis direction PO of the sapphire which is substantially parallel to the long axis direction of the cover glass 20H. Hence, there is no possibility that the cover glass 20H will be damaged.

As described above, the endoscope distal end portion according to the present embodiment includes the cylindrical distal end member that has the eighth through-hole having the expansion region which is formed in the first distal end surface and has the substantially rectangular opening having a sectional area larger than a sectional area of the deep portion, the eighth optical element that is fitted into the expansion region, is made of the single crystal sapphire having the thermal expansion coefficient smaller than the thermal expansion coefficient of the distal end member, and has a substantially rectangular second distal end surface, and the solder sealing a gap between a side surface of the eighth optical element and an inner surface of the expansion region of the eighth through-hole. The eighth optical element is disposed line-symmetrically with respect to the second imaginary line passing through a surface center of the first distal end surface. The c-axis direction of the single crystal sapphire is substantially perpendicular to the second imaginary line.

### Modification Example of Second Embodiment

A distal end member 10E of the endoscope distal end portion 8E of the present modification example illustrated in FIG. 9 includes the eighth through-hole H10H having the substantially rectangular opening in the first distal end surface 10SA, a ninth through-hole H10I having a ninth center point CH10I, and a tenth through-hole H10J having a tenth center point CH10J.

The rectangular eighth through-hole H10H is disposed line-symmetrically with respect to the second imaginary line L2 passing through the center of the first distal end surface 10SA. The cover glass 20H which is the eighth optical element is fitted into the expansion region of the eighth through-hole H10H and is fixed therein by the solder 30. The second imaginary line L2 is orthogonal to the long axis direction of the cover glass 20H.

The ninth through-hole H10I and the tenth through-hole H10J are disposed at two line-symmetrical positions with the second imaginary line L2 as a center line.

A cover glass 20I which is a ninth optical element of the illumination optical system is disposed in the ninth through-hole H10I, and a cover glass 20J which is a tenth optical element of the illumination optical system is disposed in the tenth through-hole H10J.

The largest stress is applied to the cover glass 20H made of the single crystal sapphire in the vicinity of a region D9 and in the vicinity of a region D10 in which a thickness (a dimension parallel to the first distal end surface 10SA) of the distal end member 10E is thinnest on the first distal end surface 10SA. A direction of the stress is parallel to the second imaginary line L2.

In the endoscope distal end portion 8E, since the cover glass 20H is disposed to have the c-axis direction of the sapphire which is substantially parallel to the second imaginary line L2. Hence, there is no possibility that the cover glass 20H will be damaged.

As described above, the endoscope distal end portion of the present modification example includes the cylindrical distal end member that has the eighth through-hole having the expansion region which is formed in the first distal end surface and has the substantially rectangular opening having the sectional area larger than the sectional area of the deep portion, the eighth optical element that is fitted into the expansion region, is made of the single crystal sapphire having the thermal expansion coefficient smaller than the thermal expansion coefficient of the distal end member, and has the substantially rectangular second distal end surface, and the solder sealing the gap between the side surface of the eighth optical element and the inner surface of the expansion region of the eighth through-hole. The eighth optical element is disposed line-symmetrically with respect to the second imaginary line passing through the surface center of the first distal end surface. The distal end member has the ninth through-hole having the ninth center point and the tenth through-hole having the tenth center point at line-symmetrical positions with an the second imaginary line as the center line. Into the ninth through-hole, the ninth optical element is fitted and fixed using the solder. Into the tenth through-hole, the tenth optical element is fitted and fixed using the solder. The c-axis direction of the single crystal sapphire is substantially parallel to the second imaginary line.

### Third Embodiment

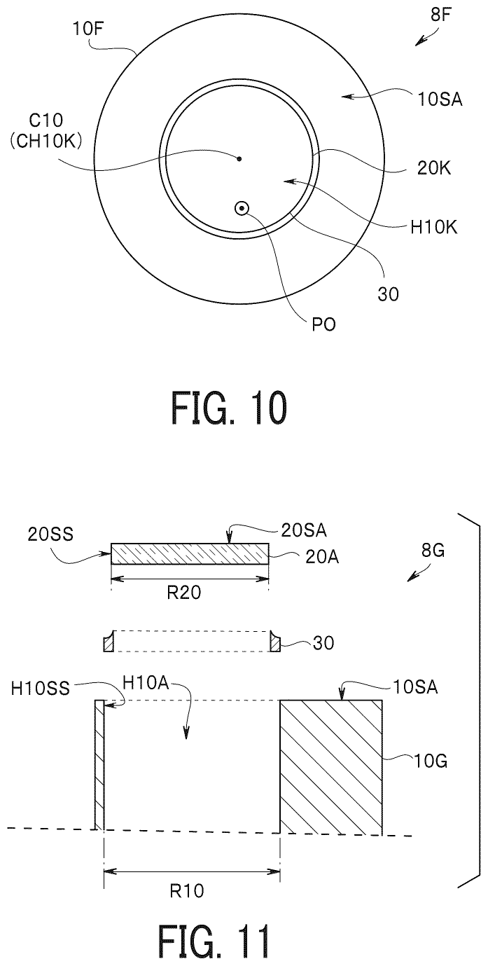

A distal end member 10F of an endoscope distal end portion 8F of the present embodiment illustrated in FIG. 10 includes an eleventh through-hole H10K having an eleventh center point CH10K in which an enlarged diameter region is formed in the first distal end surface 10SA. A center point (the eleventh center point CH10K) of a circular cover glass 20K made of the single crystal sapphire which is an eleventh optical element fitted into the enlarged diameter region is located at the same position as the surface center point C10 of the first distal end surface 10SA.

In the endoscope distal end portion 8F, stress is applied to the cover glass 20K in a perpendicular direction to the first distal end surface 10SA. Therefore, the cover glass 20 K is disposed to have the c-axis direction of the sapphire which is substantially parallel to the optical axis O of the cover glass 20K. Hence, there is no possibility that the cover glass 20K will be damaged.

As described above, the endoscope distal end portion according to the present embodiment includes the cylindrical distal end member that has the eleventh through-hole having the enlarged diameter region which is formed in the first distal end surface and has an inner diameter larger than an inner diameter of the deep portion, the eleventh optical element that is fitted into the enlarged diameter region and is made of the single crystal sapphire having the thermal expansion coefficient smaller than the thermal expansion coefficient of the distal end member, and the solder sealing a gap between a side surface of the eleventh optical element and an inner surface of the enlarged diameter region of the eleventh through-hole. The surface center point of the first distal end surface and the eleventh center point of the eleventh through-hole are located at substantially the same position, and the c-axis direction of the single crystal sapphire is substantially parallel to an optical axis of the eleventh optical element.

### Fourth Embodiment

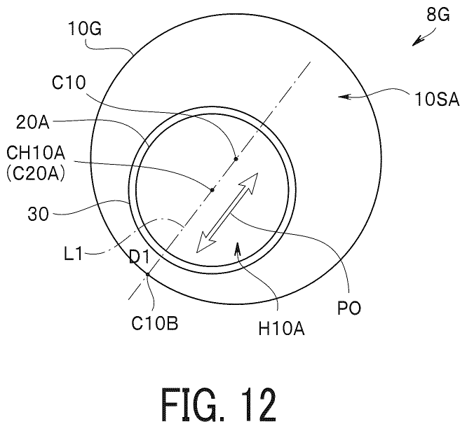

An endoscope distal end portion 8G of an endoscope 9A of the present embodiment illustrated in FIGS. 11 and 12 are similar to the endoscope distal end portion 8 illustrated in FIGS. 2 to 5. However, as illustrated in FIG. 11, the first through-hole H10A does not have an expansion region on the first distal end surface 10SA side.

The inner diameter R10 of the first through-hole H10A of a distal end member 10G is larger than the diameter R20 of the cover glass 20A by, for example, 1μm to 30 μm. The solder 30 has a ring shape to seal a gap between the side surface 20SS of the cover glass 20A and the inner surface H10SS of the first through-hole H10A.

That is, the cylindrical distal end member 10G includes the cover glass 20A which is the first optical element and the solder 30. The distal end member 10G has the first through-hole H10A in the first distal end surface 10SA. The cover glass 20A fitted into the first through-hole H10A on the distal end side is made of the single crystal sapphire having the thermal expansion coefficient smaller than that of the distal end member 10G and has the circular second distal end surface 20SA. The solder 30 seals a gap between the side surface of the cover glass 20A and the inner surface of the first through-hole H10A on the distal end side.

FIG. 12 is a plan view of the first distal end surface 10SA of the endoscope distal end portion 8G and is apparently the same as FIG. 4 (the endoscope distal end portion 8). As illustrated in FIG. 12, the c-axis direction PO of the single crystal sapphire is substantially parallel to the first imaginary line L1 connecting the surface center point C10 of the first distal end surface 10SA of the distal end member 10G (the center point CH10A of the first through-hole H10A), the first neighbor point C10B on the outer circumference of the first distal end surface 10SA which is closest to the cover glass 20A, and the first center point C20A of the first through-hole H10A.

The single crystal sapphire has the highest flexural strength in the c-axis direction. Since a direction in which strong stress is applied is a direction in which the flexural strength is high, the cover glass 20A is not likely to be damaged.

### Modification Examples of Fourth Embodiment

Endoscope distal end portions of the endoscope 9A of a plurality of following modification examples are similar to the endoscope distal end portions 8A to 8F, respectively, but do not have the enlarged diameter region (the expansion region) in the through-hole into which the cover glass is fitted, similarly to the distal end member 10G. The first distal end surfaces 10SA of the endoscope distal end portions 8A to 8F are apparently the same as those in FIGS. 5 to 10, respectively, in plan view, and thus, illustration thereof is omitted.

### Modification Example 1 of Fourth Embodiment

Similarly to the distal end member 10A illustrated in FIG. 5, a distal end member of the endoscope distal end portion of the present modification example includes a second through-hole having a second center point on an extension line of the first imaginary line, and the second optical element is fitted into the second through-hole and fixed therein using the solder.

### Modification Example 2 of Fourth embodiment

Similarly to the distal end member 10B illustrated in FIG. 6, a distal end member of the endoscope distal end portion of the present modification example includes a third through-hole having a third center point and a fourth through-hole having a fourth center point at two line-symmetrical positions with an extension line of the first imaginary line as a center line.

Into the third through-hole, a third optical element is fitted and fixed using the solder. Into the fourth through-hole, a fourth optical element is fitted and fixed using the solder.

### Modification Example 3 of Fourth Embodiment

Similarly to the distal end member 10C illustrated in FIG. 7, a distal end member of the endoscope distal end portion of the present modification example has a fifth through-hole having a fifth center point which is a forceps port, on an extension line of the first imaginary line, and the distal end member has a sixth through-hole having a sixth center point and a seventh through-hole having a seventh center point at two line-symmetrical positions with an extension line of the first imaginary line as a center line. Into the sixth through-hole, a sixth optical element is fitted and fixed using the solder. Into the seventh through-hole, a seventh optical element is fitted and fixed using the solder.

The distal end member has a plurality of through-holes, and among the plurality of through-holes, a through-hole having a center point on an extension line of the first imaginary line is the largest.

### Modification Example 4 of Fourth Embodiment

Similarly to the distal end member 10D illustrated in FIG. 8, aa distal end member of the endoscope distal end portion of the present modification example has a cylindrical distal end member that has an eighth through-hole having a substantially rectangular opening in the first distal end surface, an eighth optical element that is fitted into the eighth through-hole on a distal end side, is made of the single crystal sapphire having the thermal expansion coefficient smaller than that of the distal end member, and has a substantially rectangular second distal end surface, and the solder sealing a gap between a side surface of the eighth optical element and an inner surface of the eighth through-hole on a distal end side.

The eighth optical element is disposed line-symmetrically with respect to the second imaginary line passing through the surface center of the first distal end surface. The c-axis direction of the single crystal sapphire is substantially perpendicular to the second imaginary line.

As described above, the endoscope distal end portion of the present modification example includes the cylindrical distal end member that has the eighth through-hole having the substantially rectangular opening in the first distal end surface, the eighth optical element that is fitted into the eighth through-hole on the distal end side, is made of the single crystal sapphire having the thermal expansion coefficient smaller than that of the distal end member, and has the substantially rectangular second distal end surface, and the solder sealing the gap between the side surface of the eighth optical element and the inner surface of the eighth through-hole on the distal end side. The eighth optical element is disposed line-symmetrically with respect to the second imaginary line passing through the surface center of the first distal end surface, and the c-axis direction of the single crystal sapphire is substantially perpendicular to the second imaginary line.

### Modification Example 5 of Fourth Embodiment

Similarly to the distal end member 10E illustrated in FIG. 9, a distal end member of the endoscope distal end portion of the present modification example has a cylindrical distal end member that has an eighth through-hole having a substantially rectangular opening in the first distal end surface, an eighth optical element that is fitted into the eighth through-hole on a distal end side, is made of the single crystal sapphire having the thermal expansion coefficient smaller than that of the distal end member, and has a substantially rectangular second distal end surface, and the solder sealing a gap between a side surface of the eighth optical element and an inner surface of the eighth through-hole on a distal end side.

The eighth optical element is disposed line-symmetrically with respect to the second imaginary line passing through the surface center of the first distal end surface. The distal end member has a ninth through-hole having a ninth center point and a tenth through-hole having a tenth center point at line-symmetrical positions with the second imaginary line as a center line. Into the ninth through-hole, a ninth optical element is fitted and fixed using the solder. Into the tenth through-hole, a tenth optical element is fitted and fixed using the solder. The c-axis direction of the single crystal sapphire is substantially parallel to the second imaginary line.

As described above, the endoscope distal end portion of the present modification example includes the cylindrical distal end member that has the eighth through-hole having the substantially rectangular opening in the first distal end surface, the eighth optical element that is fitted into the eighth through-hole on the distal end side, is made of the single crystal sapphire having the thermal expansion coefficient smaller than that of the distal end member, and has the substantially rectangular second distal end surface, and the solder sealing the gap between the side surface of the eighth optical element and the inner surface of the eighth through-hole on the distal end side. The eighth optical element is disposed line-symmetrically with respect to the second imaginary line passing through the surface center of the first distal end surface. The distal end member has the ninth through-hole having the ninth center point and the tenth through-hole having the tenth center point at line-symmetrical positions with the second imaginary line as the center line. Into the ninth through-hole, the ninth optical element is fitted and fixed using the solder. Into the tenth through-hole, the tenth optical element is fitted and fixed using the solder. The c-axis direction of the single crystal sapphire is substantially parallel to the second imaginary line.

### Modification Example 6 of Fourth Embodiment

Similarly to the distal end member 10F illustrated in FIG. 10, a distal end member of the endoscope distal end portion of the present modification example has a cylindrical distal end member having an eleventh through-hole in the first distal end surface, an eleventh optical element that is fitted into the eleventh through-hole on a distal end side and is made of the single crystal sapphire having the thermal expansion coefficient smaller than that of the distal end member, and the solder sealing a gap between a side surface of the eleventh optical element and an inner surface of the eleventh through-hole on a distal end side.

The surface center point of the first distal end surface and the eleventh center point of the eleventh through-hole are located at substantially the same position. The c-axis direction of the single crystal sapphire is substantially parallel to the optical axis of the eleventh optical element.

As described above, the endoscope distal end portion of the present modification example includes the cylindrical distal end member having the eleventh through-hole in the first distal end surface, the eleventh optical element that is fitted into the eleventh through-hole on the distal end side and is made of the single crystal sapphire having the thermal expansion coefficient smaller than that of the distal end member, and the solder sealing the gap between the side surface of the eleventh optical element and the inner surface of the eleventh through-hole on the distal end side. The surface center point of the first distal end surface and the eleventh center point of the eleventh through-hole are located at substantially the same position, and the c-axis direction of the single crystal sapphire is substantially parallel to the optical axis of the eleventh optical element.

In the modification examples of the fourth embodiment, the single crystal sapphire has the highest flexural strength in the c-axis direction. Since the direction in which the strong stress is applied is the direction in which the flexural strength is high, the cover glass is not likely to be damaged.

The present disclosure is not limited to the above-described embodiments and the like, and various changes, combinations, modifications, and the like can be made within a range without changing the gist of the present disclosure.

What is claimed is:

1. An endoscope distal end portion comprising:
a cylindrical distal end member that has a first through-hole having an enlarged diameter region which is formed in a first distal end surface and has an inner diameter larger than an inner diameter of a deep portion;
a first optical element that is fitted into the enlarged diameter region, is made of a single crystal sapphire having a thermal expansion coefficient smaller than a thermal expansion coefficient of the distal end member, and has a circular second distal end surface; and
solder sealing a gap between a side surface of the first optical element and an inner surface of the enlarged diameter region of the first through-hole, wherein
a c-axis direction of the single crystal sapphire is substantially parallel to a first imaginary line connecting a surface center point of the first distal end surface of the distal end member, a first neighbor point on an outer circumference of the first distal end surface which is closest to the first optical element, and a first center point of the first through-hole.

2. The endoscope distal end portion according to claim 1, wherein
the distal end member has a second through-hole having a second center point on an extension line of the first imaginary line, and
into the second through-hole, a second optical element is fitted and fixed using solder.

3. The endoscope distal end portion according to claim 1, wherein
the distal end member has a third through-hole having a third center point and a fourth through-hole having a fourth center point at two line-symmetrical positions with an extension line of the first imaginary line as a center line,
into the third through-hole, a third optical element is fitted and fixed using solder, and
into the fourth through-hole, a fourth optical element is fitted and fixed using solder.

4. The endoscope distal end portion according to claim 1, wherein
the distal end member has a fifth through-hole having a fifth center point which is a forceps port, on an extension line of the first imaginary line,
the distal end member has a sixth through-hole having a sixth center point and a seventh through-hole having a seventh center point at two line-symmetrical positions with an extension line of the first imaginary line as a center line,
into the sixth through-hole, a sixth optical element is fitted and fixed using solder, and
into the seventh through-hole, a seventh optical element is fitted and fixed using solder.

5. The endoscope distal end portion according to claim 1, wherein
the distal end member has a plurality of through-holes, and among the plurality of through-holes, a through-hole having a center point on an extension line of the first imaginary line is the largest.

6. The endoscope distal end portion according to claim 1, wherein
the second distal end surface of the first optical element projects more than 0.1 mm and less than 0.3 mm from the first distal end surface of the distal end member.

7. The endoscope distal end portion according to claim 1, wherein
the solder covers the side surface of the first optical element without a gap.

8. The endoscope distal end portion according to claim 1, wherein
the first optical element is a parallel-plate cover glass.

9. The endoscope distal end portion according to claim 1, wherein
the distal end member is made of stainless steel.

10. The endoscope distal end portion according to claim 1, wherein
the first optical element is disposed at a distal end of an objective optical system.

11. An endoscope distal end portion comprising:
a cylindrical distal end member having a first through-hole in a first distal end surface;
a first optical element that is fitted into the first through-hole on a distal end side, is made of a single crystal sapphire having a thermal expansion coefficient smaller than a thermal expansion coefficient of the distal end member, and has a circular second distal end surface; and
solder sealing a gap between a side surface of the first optical element and an inner surface of the first through-hole on a distal end side, wherein
a c-axis direction of the single crystal sapphire is substantially parallel to a first imaginary line connecting a surface center point of the first distal end surface of the distal end member, a first neighbor point on an outer circumference of the first distal end surface which is closest to the first optical element, and a first center point of the first through-hole.

12. The endoscope distal end portion according to claim 11, wherein
the distal end member has a second through-hole having a second center point on an extension line of the first imaginary line, and
into the second through-hole, a second optical element is fitted and fixed using solder.

13. The endoscope distal end portion according to claim 11, wherein
the distal end member has a third through-hole having a third center point and a fourth through-hole having a fourth center point at two line-symmetrical positions with an extension line of the first imaginary line as a center line,
into the third through-hole, a third optical element is fitted and fixed using solder, and
into the fourth through-hole, a fourth optical element is fitted and fixed using solder.

14. The endoscope distal end portion according to claim 11, wherein
the distal end member has a fifth through-hole having a fifth center point which is a forceps port, on an extension line of the first imaginary line,
the distal end member has a sixth through-hole having a sixth center point and a seventh through-hole having a seventh center point at two line-symmetrical positions with an extension line of the first imaginary line as a center line,
into the sixth through-hole, a sixth optical element is fitted and fixed using solder, and
into the seventh through-hole, a seventh optical element is fitted and fixed using solder.

15. The endoscope distal end portion according to claim 11, wherein
the distal end member has a plurality of through-holes, and among the plurality of through-holes, a through-hole having a center point on an extension line of the first imaginary line is the largest.

16. The endoscope distal end portion according to claim 11, wherein
the second distal end surface of the first optical element projects more than 0.1 mm and less than 0.3 mm from the first distal end surface of the distal end member.

17. The endoscope distal end portion according to claim 11, wherein
the solder covers the side surface of the first optical element without a gap.

18. The endoscope distal end portion according to claim 11, wherein
the first optical element is a parallel-plate cover glass.

19. The endoscope distal end portion according to claim 11, wherein
the distal end member is made of stainless steel.

20. The endoscope distal end portion according to claim 11, wherein
the first optical element is disposed at a distal end of an objective optical system.

21. An endoscope comprising an endoscope distal end portion at a distal end portion of an insertion portion,
the endoscope distal end portion including
a cylindrical distal end member that has a first through-hole having an enlarged diameter region which is formed in a first distal end surface and has an inner diameter larger than an inner diameter of a deep portion,
a first optical element that is fitted into the enlarged diameter region, is made of a single crystal sapphire having a thermal expansion coefficient smaller than a thermal expansion coefficient of the distal end member, and has a circular second distal end surface, and
solder sealing a gap between a side surface of the first optical element and an inner surface of the enlarged diameter region of the first through-hole, wherein
a c-axis direction of the single crystal sapphire is substantially parallel to a first imaginary line connecting a surface center point of the first distal end surface of the distal end member, a first neighbor point on an outer circumference of the first distal end surface which is closest to the first optical element, and a first center point of the first through-hole.
